(19) United States
(12) Patent Application Publication
(10) Pub. No.: US 2016/0167204 A1
(43) Pub. Date: Jun. 16, 2016

(54) Insert Bit

(71) Applicant: New Way Tools Co., Ltd., Taichung City (TW)

(72) Inventor: Ping-Wen Huang, Taichung City (TW)

(21) Appl. No.: 14/595,250

(22) Filed: Jan. 13, 2015

(30) Foreign Application Priority Data
Dec. 10, 2014 (TW) 103142994

(51) Int. Cl. B25B 15/00; B25B 23/00

(52) U.S. Cl. CPC B25B 15/005; B25B 23/0035

(57) ABSTRACT

An insert bit includes a body in a one piece structure extending longitudinally along a phantom axis, a first driving tip manufactured from a first end of the body, a second driving tip manufactured from a second end of the body, and a connecting structure manufactured from the body and extending between the first and second driving tips and having a hexagonal cross section in which two opposite peripheral edges space from one another with a distance defining a transverse width which is between 0.26-0.35 times of a longitudinal length of the insert bit which defines a first length.

### BACKGROUND OF THE INVENTION

1. Field of the Invention

The present invention relates to an insert bit and, in particular, to an insert bit with a structure enabling a user thereof to use conveniently in a confined space.

2. Description of the Related Art

TW Pat. No. M478574 shows an insert bit including a first end thereof forming a driving end, a second end thereof, opposite the first end along a longitudinal length of the insert bit, forming a driven end, and a buffering portion extending between the driving and driven ends and curvedly. Like conventional insert bit, it is noted that either the buffering portion or the driven end has a substantial proportion in longitudinal length to that of the insert bit.

The present invention is, therefore, intended to provide a wrench that is easier to assemble and is made at a reduced cost than the prior art.

### SUMMARY OF THE INVENTION

According to the present invention, an insert bit enabling a user thereof to use conveniently in a confined space includes a body in a one piece structure extending longitudinally along a phantom axis, a first driving tip manufactured from a first end of the body, a second driving tip manufactured from a second end of the body, and a connecting structure manufactured from the body and extending between the first and second driving tips and having a hexagonal cross section in which two opposite peripheral edges space from one another with a distance defining a transverse width which is between 0.26-0.35 times of a longitudinal length of the insert bit which defines a first length. Each of the first and second driving tips is adapted to be used to engage with an object the insert bit intends to drive.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

It is therefore an objective of the present invention to provide an insert bit with a structure enabling a user thereof to use conveniently in a confined space.

Other objectives, advantages, and new features of the present invention will become apparent from the following detailed description of the invention when considered in conjunction with the accompanied drawings.

### BRIEF DESCRIPTION OF THE DRAWINGS

FIG. 1 is a perspective view of an insert bit in accordance with a first embodiment of the present invention.

FIG. 2 is a side view of the insert bit of the first embodiment of the present invention.

FIG. 3 is a top view of the insert bit of the first embodiment of the present invention.

FIG. 4 is a perspective view of an insert bit in accordance with a second embodiment of the present invention.

FIG. 5 is a perspective view of an insert bit in accordance with a third embodiment of the present invention.

### DETAILED DESCRIPTION OF THE INVENTION

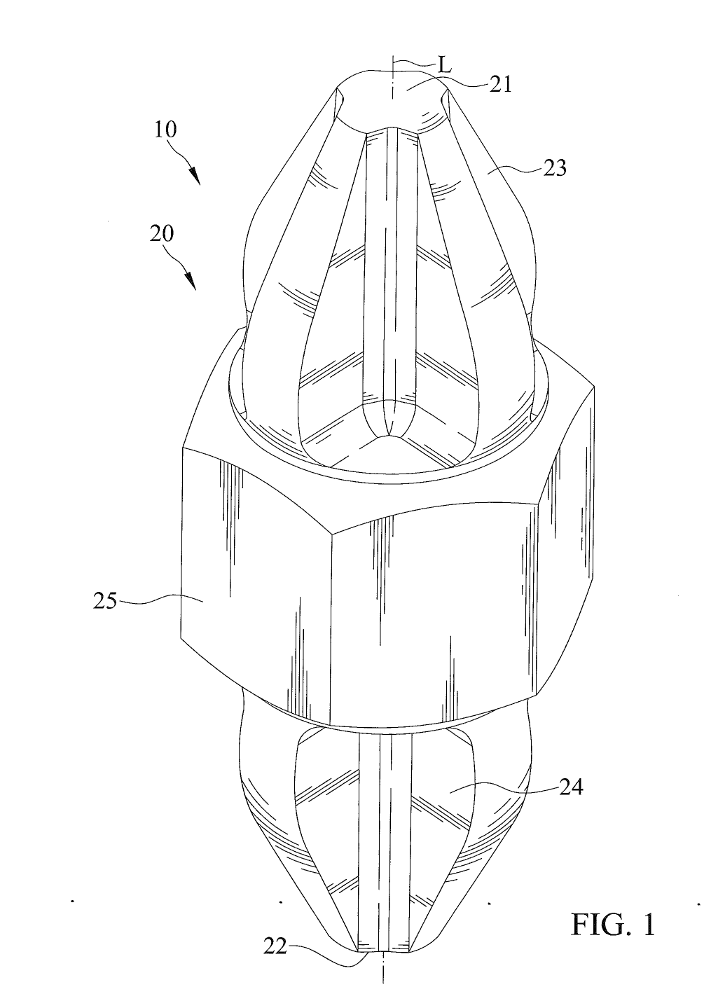

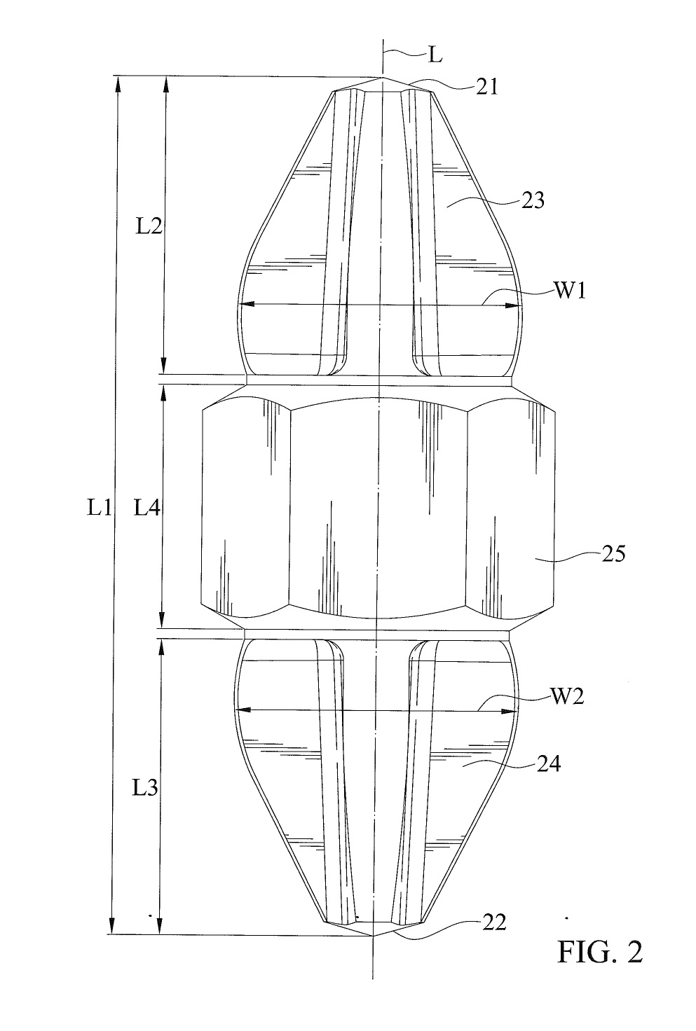

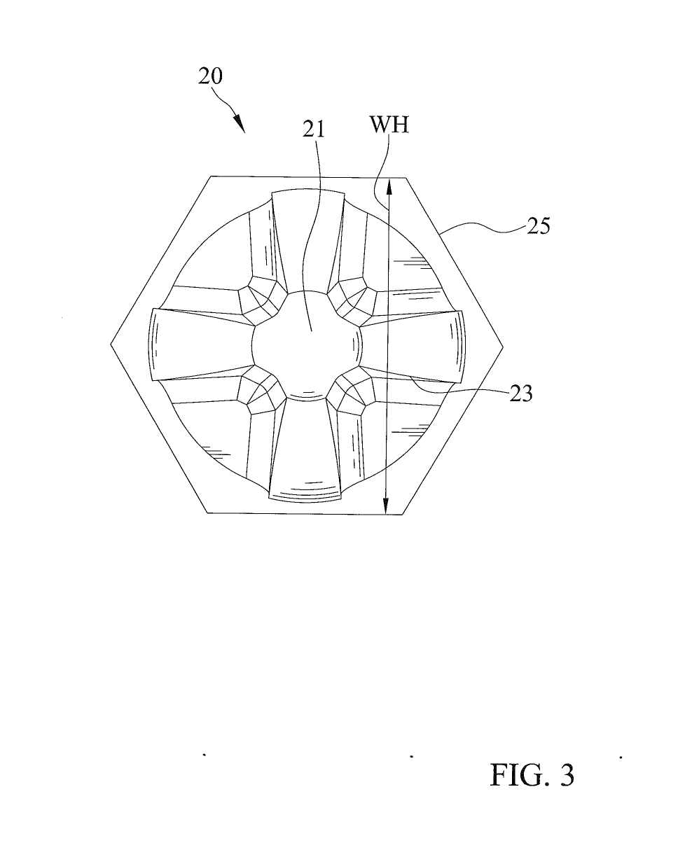

FIGS. 1 through 3 show an insert bit 10 in accordance with a first embodiment of the present invention. The insert bit 10 includes a body 20 in a one piece structure extending longitudinally along a phantom axis L, a first driving tip 23 manufactured from a first end of the body 20, a second driving tip 24 manufactured from a second end of the body 20, and a connecting structure 25 manufactured from the body 20 and extending between the first and second driving tips 23 and 24 and having a hexagonal cross section in which two opposite peripheral edges space from one another with a distance defining a transverse width WH which is between 0.26-0.35 times of a longitudinal length of the insert bit 10 which defines a first length L1. The first length L1 is in a range of 18 millimeters to 24 millimeters.

The first and second driving tips 23 and 24 and the connecting structure 25 are manufactured from the body 20. Therefore, the body 20, the first and second driving tips 23 and 24 and the connecting structure 25 are made of the same material.

The body 20 has a first end 21, a second end 22 opposite the first end 21, and the longitudinal length measuring between first and second ends thereof 21 and 22.

Each of the first and second driving tips 23 and 24 is adapted to be used to engage with an object the insert bit 10 intends to drive. Each of the first and second driving tips 23 and 24 may have an X shape cross section in which it includes a plurality of wings. The first driving tip 23 extends longitudinally along the phantom axis L and has a longitudinal length that defines a second length L2 and that is between 0.3-0.4 times of the first length L1. The first driving tip 23 has a maximum width that is radial to the phantom axis L and that defines a first width W1 and that is between 0.8-0.9 times of the transverse width WH and that is between 0.3-0.35 times of the first length L1. The second driving tip 24 extends longitudinally along the phantom axis L and has a longitudinal length that defines a third length L3 and that is between 0.3-0.4 times of the first length L1. The second driving tip 24 has a maximum width that is radial to the phantom axis L and that defines a second width W2 and that is between 0.8-0.9 times of the transverse width WH and that is between 0.3-0.35 times of the first length L1. The second and third lengths L2 and L3 may equal.

The connecting structure 25 has a polygonal periphery including peripheral edges radially spaced from the phantom axis L. Since the connecting structure 25 has a hexagonal cross section, the connecting structure 25 has a hexagonal periphery. The connecting structure 25 interconnects the first and second driving tips 23 and 24 of the insert bit 10. The connecting structure 25 extends longitudinally along the phantom axis L and has a longitudinal length that defines a fourth length L4 and that is between 0.25-0.35 times of the first length L1.

The insert bit 10 is adapted to connect to an external driving tool and include the connecting structure 25 connecting to holding structures of the external driving tool.

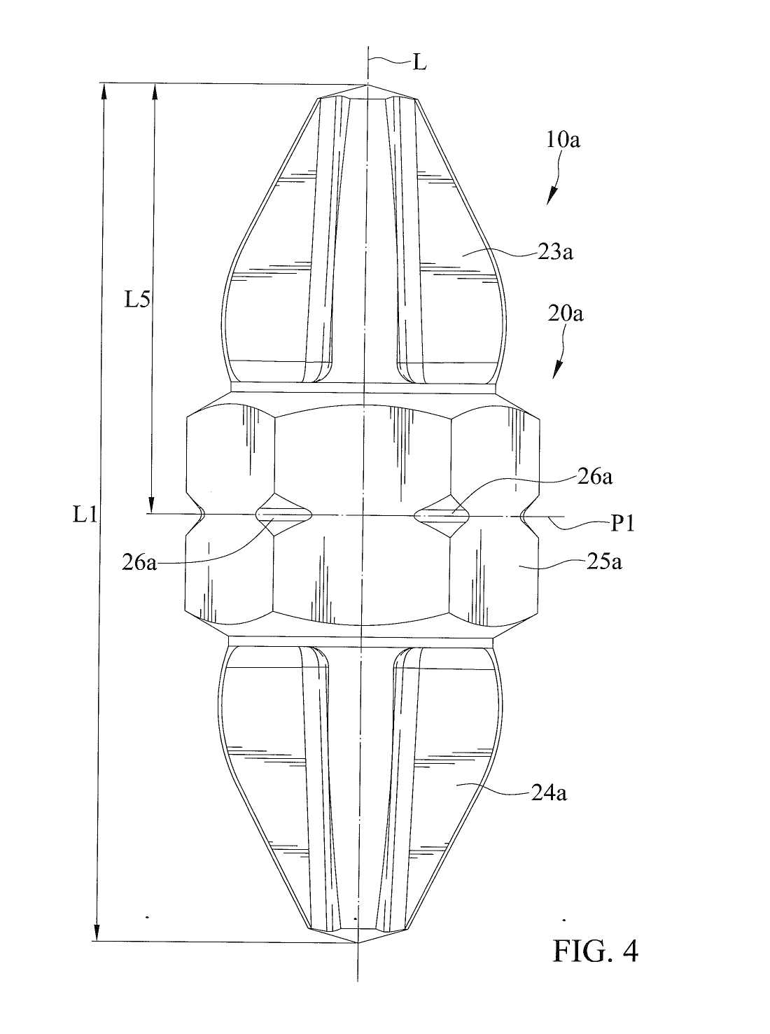

FIG. 4 shows an insert bit 10a in accordance with a second embodiment of the present invention. Likewise, the insert bit 10a includes a body 20a in a one piece structure extending longitudinally along the phantom axis L. The insert bit 10a is similar to the insert bit 10 except that it includes a connecting structure 25a in which a periphery thereof includes at least one first recess 26a. The at least one first recess 26a has a depth extending radially with respect to the phantom axis L. The at least one first recess 26a extends on a corner interconnecting two peripheral edges of the periphery of the connecting structure 25a. The at least one first recess 26a is aligned with a first plane P1 which is perpendicular to the phantom axis L. The first plane P1 is distal to a distal end of the insert bit 10a and a tip end of a first driving tip 23a at a distance defining a fifth length L5. The fifth length L5 is between 0.4-0.6 times of the first length L1, which defines the longitudinal length of the insert bit 10a. The insert bit 10a is adapted to connect to an external driving tool and include the connecting structure 25a and the at least one first recess 26a connecting to holding structures of the external driving tool.

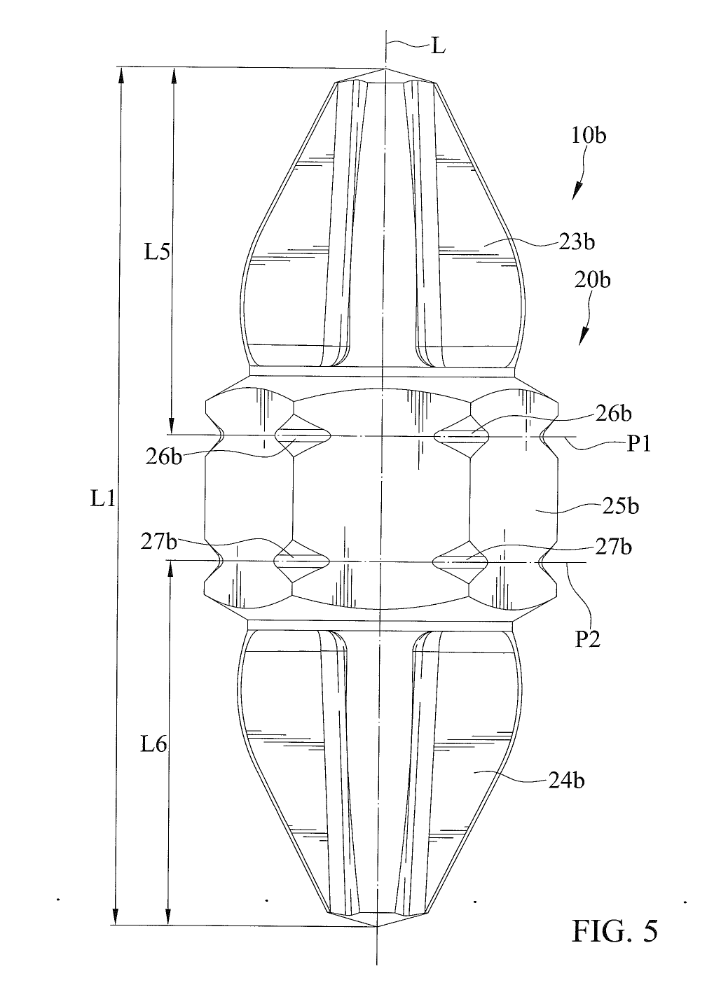

FIG. 5 shows an insert bit 10b in accordance with a third embodiment of the present invention. Likewise, the insert bit 10b includes a body 20b in a one piece structure extending longitudinally along the phantom axis L. The insert bit 10b is similar to the insert bit 10 except that it includes a connecting structure 25b in which a periphery thereof includes at least one first recess 26b. The at least one first recess 26b has a depth extending radially with respect to the phantom axis L. The at least one first recess 26b extends on a corner interconnecting two peripheral edges of the periphery of the connecting structure 25b. The at least one first recess 26b is aligned with a first plane P1 which is perpendicular to the phantom axis L. The first plane P1 is distal to a distal end of the insert bit 10b and a tip end of a first driving tip 23b at a distance defining a fifth length L5. The fifth length L5 is between 0.4-0.6 times of the first length L1, which defines the longitudinal length of the insert bit 10b. Moreover, the periphery of the connecting structure 25b includes at least one second recess 27b. The at least one second recess 27b has a depth extending radially with respect to the phantom axis L. The at least one second recesses 27b extends on a corner interconnecting two peripheral edges of the periphery of the connecting structure 25b. The at least one first and second recesses 26b and 27b extend on the same corner of the connecting structure 25b. The at least one second recess 27b is aligned a second plane P2 which is perpendicular to the phantom axis L. The second plane P2 is distal to a distal end of the insert bit 10b and a tip end of the second driving tip 24b at a distance defining a sixth length L6. The insert bit 10a is adapted to connect to an external driving tool and include the connecting structure 25a and the at least one first and second recesses 26b and 27b connecting to holding structures of the external driving tool. Each of the fifth and sixth lengths L5 and L6 is between 0.4-0.45 times of the first length L1. The fifth and sixth lengths L5 and L6 may equal.

In view of the forgoing, the transverse width WH is between 0.26-0.35 times of the first length L1. The first length L1 is in a range of 18 millimeters to 24 millimeters. Each of the second and third lengths L2 and L3 is between 0.3-0.4 times of the first length L1. Each of the first and second width W1 and W2 is between 0.8-0.9 times of the transverse width WH and is between 0.3-0.35 times of the first length L1. The fourth length L4 is between 0.25-0.35 times of the first length L1.

While the specific embodiments have been illustrated and described, numerous modifications come to mind without significantly departing from the spirit of invention, and the scope of invention is only limited by the scope of the accompanying claims.

What is claimed is:

1. An insert bit enabling a user thereof to use conveniently in a confined space comprising:
a body in a one piece structure extending longitudinally along a phantom axis, a first driving tip manufactured from a first end of the body, a second driving tip manufactured from a second end of the body, and a connecting structure manufactured from the body and extending between the first and second driving tips and having a hexagonal cross section in which two opposite peripheral edges space from one another with a distance defining a transverse width which is between 0.26-0.35 times of a longitudinal length of the insert bit which defines a first length;
wherein each of the first and second driving tips is adapted to be used to engage with an object the insert bit intends to drive.

2. The insert bit as claimed in claim 1, wherein the first length is in a range of 18 millimeters to 24 millimeters.

3. The insert bit as claimed in claim 1, wherein the first driving tip extends longitudinally along the phantom axis and has a longitudinal length that defines a second length and that is between 0.3-0.4 times of the first length, wherein the second driving tip extends longitudinally along the phantom axis and has a longitudinal length that defines a third length and that is between 0.3-0.4 times of the first length, and wherein the connecting structure extends longitudinally along the phantom axis and has a longitudinal length that defines a fourth length and that is between 0.25-0.35 times of the first length.

4. The insert bit as claimed in claim 2, wherein the first driving tip extends longitudinally along the phantom axis and has a longitudinal length that defines a second length and that is between 0.3-0.4 times of the first length, wherein the second driving tip extends longitudinally along the phantom axis and has a longitudinal length that defines a third length and that is between 0.3-0.4 times of the first length, and wherein the connecting structure extends longitudinally along the phantom axis and has a longitudinal length that defines a fourth length and that is between 0.25-0.35 times of the first length.

5. The insert bit as claimed in claim 3, wherein the second and third lengths are equal.

6. The insert bit as claimed in claim 4, wherein the second and third lengths are equal.

7. The insert bit as claimed in claim 1, wherein the first driving tip has a maximum width that is radial to the phantom axis and that defines a first width and that is between 0.8-0.9 times of the transverse width, and wherein the second driving tip has a maximum width that is radial to the phantom axis and that defines a second width and that is between 0.8-0.9 times of the transverse width.

8. The insert bit as claimed in claim 4, wherein the first driving tip has a maximum width that is radial to the phantom axis and that defines a first width and that is between 0.8-0.9 times of the transverse width, and wherein the second driving tip has a maximum width that is radial to the phantom axis and that defines a second width and that is between 0.8-0.9 times of the transverse width.

9. The insert bit as claimed in claim 7, wherein the first width is between 0.3-0.35 times of the first length, and wherein the second width is between 0.3-0.35 times of the first length.

10. The insert bit as claimed in claim 8, wherein the first width is between 0.3-0.35 times of the first length, and wherein the second width is between 0.3-0.35 times of the first length.

11. The insert bit as claimed in claim 1, wherein the connecting structure has a periphery thereof including at least one first recess, wherein the at least one first recess has a depth extending radially with respect to the phantom axis, wherein the at least one first recess is aligned with a first plane which is perpendicular to the phantom axis, wherein the first plane is distal to a distal end of the insert bit and a tip end of the first driving tip at a distance defining a fifth length, wherein the fifth length is between 0.4-0.6 times of the first length, and wherein the insert bit is adapted to connect to an external driving tool and include the connecting structure and the at least one first recess connecting to holding structures of the external driving tool.

12. The insert bit as claimed in claim 10, wherein the connecting structure has a periphery thereof including at least one first recess, wherein the at least one first recess has a depth extending radially with respect to the phantom axis, wherein the at least one first recess is aligned with a first plane which is perpendicular to the phantom axis, wherein the first plane is distal to a distal end of the insert bit and a tip end of the first driving tip at a distance defining a fifth length, wherein the fifth length is between 0.4-0.6 times of the first length, and wherein the insert bit is adapted to connect to an external driving tool and include the connecting structure and the at least one first recess connecting to holding structures of the external driving tool.

13. The insert bit as claimed in claim 11, wherein the periphery of the connecting structure includes at least one second recess, wherein the at least one second recess has a depth extending radially with respect to the phantom axis, wherein the at least one second recess is aligned a second plane which is perpendicular to the phantom axis, wherein the second plane is distal to a distal end of the insert bit and a tip end of the second driving tip at a distance defining a sixth length, wherein each of the fifth and sixth lengths is between 0.4-0.45 times of the first length, and wherein the insert bit is adapted to connect to an external driving tool and include the connecting structure and the at least one first and second recesses connecting to holding structures of the external driving tool.

14. The insert bit as claimed in claim 12, wherein the periphery of the connecting structure includes at least one second recess, wherein the at least one second recess has a depth extending radially with respect to the phantom axis, wherein the at least one second recess is aligned a second plane which is perpendicular to the phantom axis, wherein the second plane is distal to a distal end of the insert bit and a tip end of the second driving tip at a distance defining a sixth length, wherein each of the fifth and sixth lengths is between 0.4-0.45 times of the first length, and wherein the insert bit is adapted to connect to an external driving tool and include the connecting structure and the at least one first and second recesses connecting to holding structures of the external driving tool.

15. The insert bit as claimed in claim 13, wherein the fifth and sixth lengths are equal.

16. The insert bit as claimed in claim 14, wherein the fifth and sixth lengths are equal.

17. The insert bit as claimed in claim 11, wherein the at least one first recess extends on a corner interconnecting two peripheral edges of the periphery of the connecting structure.

18. The insert bit as claimed in claim 13, wherein each of the at least one first and second recesses extends on a corner interconnecting two peripheral edges of the periphery of the connecting structure.

19. The insert bit as claimed in claim 18, wherein the at least one first and second recesses extend on a same corner interconnecting two peripheral edges of the periphery of the connecting structure.
